(19) United States
(12) Patent Application Publication
(10) Pub. No.: US 2025/0350489 A1
(43) Pub. Date: Nov. 13, 2025

(54) SOURCE ATTRIBUTION DISTRIBUTION ACROSS DISPARATE HOME NETWORKS

(71) Applicant: Apple Inc., Cupertino, CA (US)

(72) Inventors: Anush G. NADATHUR, San Jose, CA (US); Justin N. WOOD, Los Altos, CA (US)

(21) Appl. No.: 19/046,464

(22) Filed: Feb. 5, 2025

Related U.S. Application Data
(60) Provisional application No. 63/645,071, filed on May 9, 2024.

(51) Int. Cl. H04L 12/28

(52) U.S. Cl. CPC H04L 12/2827; H04L 12/282

(57) ABSTRACT

Networks, such as home networks, may communicate and distribute a source attribute change used to change the state of a network device. The network can provide the source attribute change to an electronic device even in instances when the network device and the electronic device include different device types and are connected to different networks. Using the source attribute change information, the electronic device can identify the source (e.g., another electronic device) that caused the change of state to the network device.

### CROSS REFERENCE TO RELATED APPLICATION(S)

The present application claims the benefit of U.S. Provisional Application No. 63/645,071, entitled “SOURCE ATTRIBUTION DISTRIBUTION ACROSS DISPARATE HOME NETWORKS”, filed May 9, 2024, the entirety of which is incorporated herein for reference.

### TECHNICAL FIELD

This application is directed to sharing information with an electronic device on a network, and more particularly, to sharing source information related to an attribute change of a network device when the electronic device and the network device are on disparate home networks.

### BACKGROUND

User devices, such as smartphones, can receive a user input to control one or more functions of a network device, or “smart” device, connected to a network, such as a home network. In this regard, the user input can change the state of the network device. In some instances, the user device and the network device are on different networks. As a result, when another user device provides a user input to control a function of the network device, the user device may receive a notification or indication that the state of the network device has changed.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example of a network environment of a system in which a source that changed an attribute of a device may be communicated, e.g., across disparate home networks, in accordance with aspects of the present disclosure.

FIG. 2 illustrates a block diagram of an example of an electronic device that may be used to obtain the source attribute information that caused a change of state of a network device, in accordance with aspects of the present disclosure.

FIG. 3 illustrates a block diagram showing network hubs connected to devices based on respective device types, in accordance with aspects of the present disclosure.

FIG. 4 illustrates the network environment in which the electronic device may obtain source information that causes a change of state of the network device, in accordance with aspects of the present disclosure.

FIG. 5 illustrates the network environment in which the electronic device may obtain source information based on a user having user accounts on different network, in accordance with aspects of the present disclosure.

FIG. 6 illustrates a flow diagram showing an example of a process that may be performed for obtaining a source that caused a state of change to a network device, in accordance with aspects of the present disclosure.

FIG. 7 illustrates a flow diagram showing an example of a process that may be performed for encoding information associated with a source that caused a state of change to a network device, in accordance with aspects of the present disclosure.

FIG. 8 illustrates a flow diagram showing an alternate example of a process that may be performed for obtaining a source that caused a state of change to a network device, in accordance with aspects of the present disclosure.

FIG. 9 illustrates a flow diagram showing an alternate example of a process that may be performed for obtaining a source that caused a state of change to a network device, in accordance with aspects of the present disclosure.

FIG. 10 illustrates a flow diagram showing an alternate example of a process that may be performed for obtaining a source that caused a state of change to a network device, in accordance with aspects of the present disclosure.

FIG. 11 illustrates a flow diagram showing an alternate example of a process that may be performed for obtaining a source that caused a state of change to a network device, in accordance with aspects of the present disclosure.

FIG. 12 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is directed to providing a user device with information regarding the cause of a change of state (e.g., attribute change) of a network device. Moreover, in one or more implementations, the information may be communicated between the user device and the network device while the user device and network devices are on disparate networks, such as different networks and/or are part of different interconnected systems (e.g., ecosystems). As an example, a first user device is connected to a first network and uses a second network to change state or attribute (e.g., lock, unlock) of a network device (e.g., door lock) that is operatively connected to a third network. When a second user device unlocks the door lock, the first network receives a notification via the second network that the door lock was unlocked, including the source information attributed to the door unlock event. In this regard, the second network may serve as a cross-ecosystem supported network between the first network and the third network. The notification may include an indication (e.g., message) that the second user device unlocked the door lock. As an alternative, the first network may receive a notification that the door lock was physically altered (e.g., by a person) to unlock the door lock. As yet another alternative, the first network may receive a notification that the door lock was automatically unlocked based on a script, or smart automation, previously established.

Additionally, it may be desirable to preserve the privacy of user devices, including the user of a user device, so as to limit or prevent identification of the user devices and/or the user by another network or devices on another network. For example, an opaque identifier may be used to encode information (e.g., instructions, commands) transmitted by a first user device that has a first device type on the first network such that the user device can be identified only by other user devices of the first device type that are on the first network. Put another way, if a second user device of a second device type receives the information, the opaque identifier prevents the second user device from identifying the first user device or the user of the first user device.

Accordingly, the subject technology described herein offers several advantages. For example, the first user device can use the first network and the second network to not only determine that the door lock was unlocked, but also how the door lock was unlocked, and in some cases who unlocked the door lock (e.g., a user is associated with the second user device) despite the first user device and the network device being part of disparate networks, and in some cases, different device types (e.g., different operating systems) and/or on networks with different networking protocols. As another example, user devices of the first device type on the first network may communicate data (e.g., an indication as to which device is the source that changed an attribute of the network device) with each other using encoded data or opaque data, thus preventing other devices of the second device type from reading the data, or otherwise preventing the other user devices from making use of the data if received.

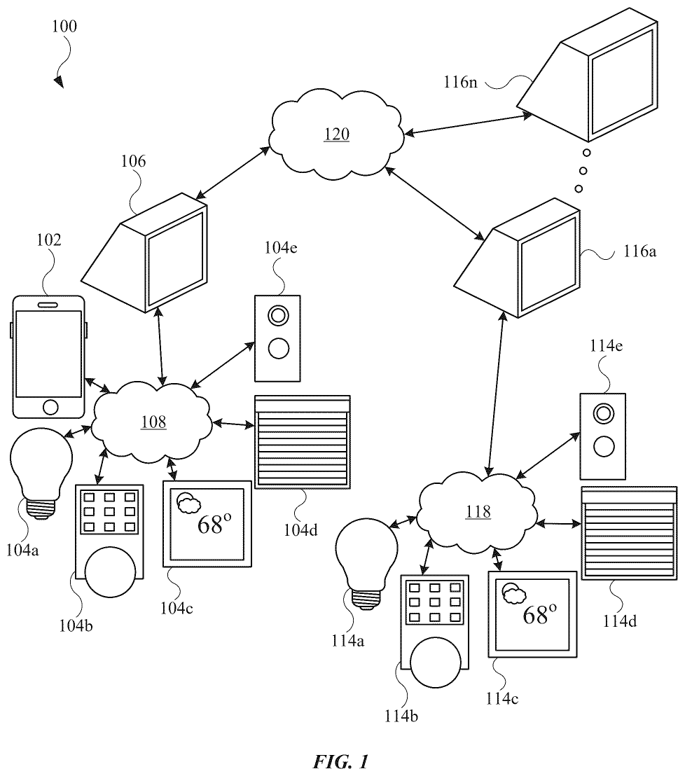

These and other embodiments are discussed below with reference to FIGS. 1-12. However, those skilled in the art will readily appreciate that the detailed description given herein with respect to these Figures is for explanatory purposes only and should not be construed as limiting.

FIG. 1 illustrates an example of a network environment of a system in which a source that changed an attribute of a device may be communicated, e.g., across disparate home networks, in accordance with aspects of the present disclosure. Not all of the depicted components may be used in all implementations, however, and one or more implementations may include additional or different components than those shown in FIG. 1. Variations in the arrangement and type of the components may be made without departing from the spirit or scope of the claims as set forth herein. Additional components, different components, or fewer components may be provided.

As a non-limiting example, the network environment 100 may include an electronic device 102, a network device 104a, a network device 104b, a network device 104c, a network device 104d, a network device 104e, a network hub 106, and a network 108 communicatively (directly or indirectly) coupled to the electronic device 102, the network devices 104a, 104b, 104c, 104d, 104e, and the network hub 106. Additionally, the network environment 100 may include a network device 114a, a network device 114b, a network device 114c, a network device 114d, a network device 114e, network hubs (e.g., a network hub 116a, a network hub 116n, representing n network hubs), and a network 118 communicatively (directly or indirectly) coupled to the network devices 114a, 114b, 114c, 114d, 114e, and the network hub 116a. Further, the network environment 100 may include a network 120 connected to the network hubs 106 and 116a. Each of the networks 108, 118 and 120 may be an interconnected network of devices that may include, or may be communicatively coupled to, the Internet. For explanatory purposes, the network environment 100 is illustrated in FIG. 1 as including the electronic device 102, the network devices 104a, 104b, 104c, 104d, 104e, 114a, 114b, 114c, the network hubs 106 and 116a, and the networks 108, 118, and 120. However, the network environment 100 may include any number of electronic devices and/or any number of servers communicatively coupled to each other directly or via the network 108 and/or the network 118.

The network 120 may communicatively (directly or indirectly) couple with one or more of the network hub 106 and the network hubs 116a and 116n (e.g., each of the n network hubs), as well as the networks 108 and 118. In this regard, the network 120 may also communicatively (directly or indirectly) couple with one or more of the respective devices communicatively coupled to the networks 108 and 118.

In one or more implementations, the network environment 100 is integrated in a home, office, and/or other common dwelling and/or space. In this regard, each of the network hub 106 and the network hubs 116a and 116n (e.g., each of the n network hubs) may be referred to as a home network hub, and each of the networks 108, 118, and 120 may be referred to as a home network. Additionally, each of the network hubs 116a and 116n may take the form of a network manager, such as a router or an access point.

The electronic device 102 may take the form of, for example, a wearable device such as a watch (or smartwatch), a portable computing device (e.g., a smartphone, a tablet device), or any other appropriate device that includes, for example, one or more wireless interfaces, such as WLAN radios, cellular radios, BLUETOOTH® radios, Zigbee radios, Thread radios, near field communication (NFC) radios, and/or other wireless radios. In FIG. 1, by way of example, each of the electronic device 102 is depicted as a smartphone.

The network devices 104a and 114a may take the form a lightbulb that is part of a lighting system (e.g., smart lighting system). The network devices 104b and 114b may take the form of a door lock (e.g., smart door lock). The network devices 104c and 114c may take the form of a thermostat (e.g., smart thermostat). The network devices 104d and 114d may take the form of a motorized blind. The network devices 104e and 114e may take the form of a doorbell (e.g., smart doorbell) that includes a camera. Other types of network devices may also be possible. For example, a network device shown and/or described herein may take the form of, for example, a camera, a security system, a faucet, a motion sensor, a plug/outlet, a motorized blind, and/or generally home device and/or accessory. Generally, each of the network devices 104a, 104b, 104c, 104d, 104e, 114a, 114b, 114c, 114d, and 114e may be a “smart” device that may be connected to one or more networks (e.g., the network 108 or, the network 118) and as a result may be operated or controlled remotely by the electronic device 102. Similar to the electronic device 102, the network devices 104a, 104b, 104c, 104d, 104e, 114a, 114b, 114c, 114d, and 114e may include, for example, one or more wireless interfaces, such as WLAN radios, cellular radios, BLUETOOTH® radios, Zigbee radios, Thread radios, near field communication (NFC) radios, and/or other wireless radios.

As shown, each of the network hubs 106, 116a, and 116n includes a display (not labeled). However, in or more implementations, one or more of the network hubs 106 and 116a does not include a display. The network hub 106 may communicate with the network 108 and receive updates from any of the network devices 104a, 104b, 104c, 104d, and 104e connected to the network 108 indicating a change of state of the respective device. For example, the network hub 106 may receive an update that the network device 104b was unlocked (e.g., transitioned from a locked state to an unlocked state). Additionally, the network hub 106 may receive an input (e.g., touch input or gesture to the display, voice command) from a user that is used to change the state of the network devices 104a, 104b, 104c, 104d, and 104e. For example, the network hub 106 may receive an input from a user to unlock the network device 104b. Similarly, the network hub 116a may communicate with the network 118 and receive updates from any of the network devices 114a, 114b, 114c, 114d, and 114e connected to the network 118 indicating a change of state of the respective device, as well as receive an input from a user to change the state of the network devices 114a, 114b, 114c, 114d, and 114e. Although not shown, the network hub 116n may include any number of network devices to which the network hub 116n is communicatively coupled.

In one or more implementations, each of the network hubs 106, 116a, and 116n communicates the updates from respective network devices connected to the network hubs 106, 116a, and 116n to the network 120. Moreover, the network hubs 106 and 116a may receive the updates via the network 120. For example, the network hub 106 may receive data, via the network 120, indicating a change of state to one or more of the network devices 114a, 114b, 114c, 114d, and 114e. This will be discussed in further detail below.

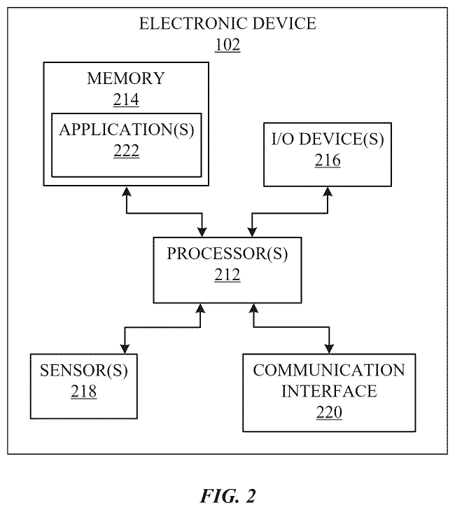

FIG. 2 illustrates a block diagram of an example of an electronic device 102 that may be used to obtain the source attribute information that caused a change of state of a network device (e.g., network devices 104a, 104b, 104c, 104d, 104e, 114a, 114b, 114c, 114d, and 114e shown in FIG. 1), in accordance with aspects of the present disclosure. The electronic device 102 shown in FIG. 2 may be implemented in any other electronic device for use with the subject technology. In this regard, the electronic device 102 may be used with smart home automation and may also function to control and cause a change of state of a network device. Variations in the arrangement and type of the components may be made without departing from the spirit or scope of the claims as set forth herein. Additional components, different components, or fewer components may be provided.

The electronic device 102 may include one or more processors 212, a memory 214, one or more input-output devices 216 (I/O devices(s)), one or more sensors 218, and a communication interface 220. The one or more processors 212 may include a central processing unit, a graphics processing unit, one or more microcontrollers, one or more application specific integrated circuits, or a combination thereof. Further, the one or more processors 212 may include suitable logic, circuitry, and/or code that enable processing data and/or controlling operations of the electronic device 102. In this regard, the one or more processors 212 may be enabled to provide control signals to various other components of the electronic device 102. The one or more processors 212 may also control transfers of data between various portions of the electronic device 102. The one or more processors 212 may further implement an operating system or may otherwise execute code to manage operations of the electronic device 102. The one or more processors 212 are communicatively coupled to the various components shown in FIG. 2.

The memory 214 may include suitable logic, circuitry, and/or code that enable storage of various types of information such as received data, generated data, code, and/or configuration information. The memory 214 may include volatile memory (e.g., random access memory (RAM)) and/or non-volatile memory (e.g., read-only memory (ROM), flash, and/or magnetic storage). In one or more implementations, the memory 214 may store user account data, and any other data generated in the course of performing the processes described herein.

The memory 214 may store one or more applications 222. The one or more applications 222 may include an application used to communicate with and control one or more network devices. In this regard, the one or more applications 222 may include an application that communicates with a network device (e.g., network device 104a, 104b, 104c, 104d, 104e, 114a, 114b, 114c, 114d, and 114e shown in FIG. 1) and/or an application that communicates with a network hub (e.g., network hub 106 and/or network hub 116a shown in FIG. 1). Further, using the one or more applications 222, the electronic device 102 may establish automation and generate one or more automated controls used to control a network device to provide an automated change of a state of the network device based upon predetermined conditions, such as turning on a lighting system at a preset time or turning off the lighting system at a preset time, as non-limiting examples.

The one or more input-output devices 216 may include a display. In one or more implementations, the display includes a capacitive touch input display, thus allowing the user to interact with the electronic device 102 via a touch input or gesture to the display. Additionally, the one or more input-output devices 216 may include one or more buttons, which may be actuated by a user of the electronic device 102. The one or more input-output devices 216, while taking the form of a display and/or buttons, may be used to provide an input to the one or more processors 212 in order to, for example, initiate a payment through a payment provider. Further, the one or more input-output devices 216 may include an audio module (e.g., speaker) designed to convert electrical signals into soundwaves in the form of audible sound. The one or more input-output devices 216 may include one or more microphones and/or cameras. The microphones may obtain audio signals, such as voice commands from a user to initiate a voice command to, for example, change a state of a network device. For example, the microphones may obtain audio of the user providing a command to lock a door.

The one or more sensors 218 may include one or more image sensors (e.g., camera, proximity sensor). The one or more sensors 218 may detect whether a user is interacting with the electronic device 102.

The communication interface 220 may include suitable logic, circuitry, and/or code that enables wired or wireless communication, such as between the electronic device 102 and the network 120 (shown in FIG. 1). The communication interface 220 may include, for example, one or more of a BLUETOOTH® communication interface, an NFC interface, a Zigbee communication interface, a Thread interface, a WLAN communication interface, a Universal Serial Bus (USB) communication interface, a cellular interface, or generally any communication interface. Accordingly, the communication interface 220 may establish a radio network, allowing the electronic device 102 to communicate with another device (e.g., the network devices 104a, 104b, 104c, 114a, 114b, 114c, 114d, and 114e shown in FIG. 1). In one or more implementations, electronic devices described herein may use respective communication interfaces to detect another electronic device and to determine whether the electronic devices are within proximity to each other.

In one or more implementations, the one or more processors 212, the memory 214, the one or more input-output devices 216, the one or more sensors 218, the communication interface 220, and/or one or more portions thereof may be implemented in software (e.g., subroutines and code), may be implemented in hardware (e.g., an Application Specific Integrated Circuit (ASIC)), a Field Programmable Gate Array (FPGA), a Programmable Logic Device (PLD), a controller, a state machine, gated logic, discrete hardware components, or any other suitable devices) and/or a combination thereof.

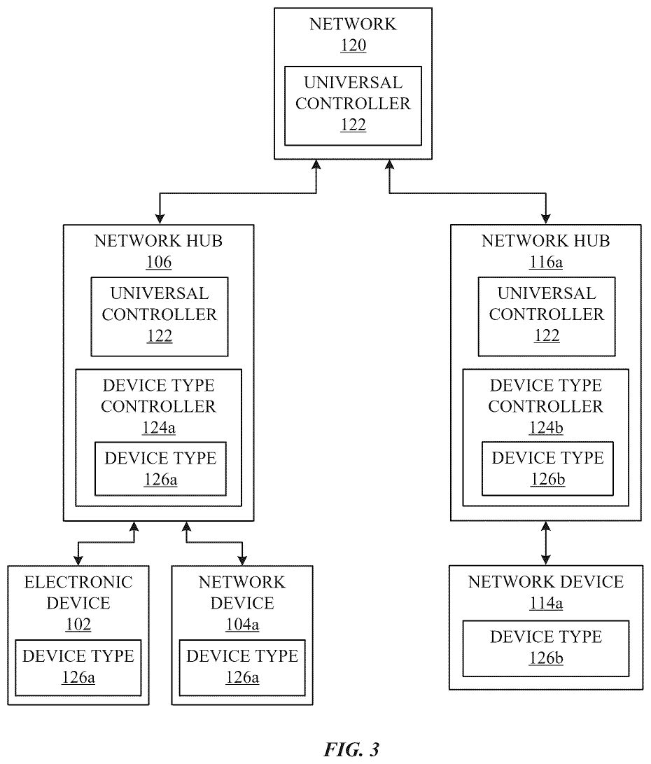

FIG. 3 illustrates a block diagram showing network hubs connected to devices based on respective device types, in accordance with aspects of the present disclosure. In order for the network hubs 106 to communicate with the network 120, each of the network hubs 106, 116a, and the network 120 may include a universal controller 122. As a non-limiting example, the universal controller 122 may include a central processing unit, one or more microcontrollers, one or more application specific integrated circuits, or a combination thereof. Based on the network hubs 106 and 116a and the network 120 having the universal controller 122, the network hubs 106 and 116a may communicate updates (e.g., from respective devices) to the network 120. Additionally, the network 120 may communicate updates, received from the network hub 116a, to the network hub 106.

In one or more implementations, the network hubs 106 and 116a are designed to run on different interconnected systems. Further, the network hubs 106 and 116a may be of different device types due to, for example, the network hubs 106 and 116a running on different operating systems, different networking protocol, and/or different platforms. For example, the network hub 106 may include a device type controller 124a designed to control devices of a device type 126a and may communicatively couple to devices associated with the device type 126a, such as the electronic device 102 and the network device 104a (representative of the network devices 104b, 104c, 104d, and 104e shown in FIG. 1), each of which having the device type 126a. Accordingly, the electronic device 102 and the network device 104a, having the device type 126a, can communicate over the network hub 106. Also, the network hub 116a may include a device controller 124b designed to control devices of a device type 126b and may communicatively couple to devices associated with the device type 126b, such as the network device 114a (representative of the network devices 114b, 114c, 114d, and 114e shown in FIG. 1), which also has the device type 126b. Accordingly, the network device 114a, having the device type 126b, can communicate over the network hub 116a. Conversely, however, the electronic device 102 and the network device 104a may not communicate over the network hub 116a, and the network device 114a may not communicate over the network hub 106.

The network 120 may function to support devices associated with either of the device type 126a or the device type 126b. As a result, the network 120 may provide functionality to allow communication between the electronic device 102 and the network device 114a, despite the electronic device 102 and the network device 114a being associated with different device types and different interconnected systems. Moreover, in one or more implementations, the electronic device 102 can not only control, via the network 120, the network device 114a, but also receive, via the network 120, data indicating source information (e.g., another device) that caused a change of state of the network device 114a. This will be shown and described in further detail below.

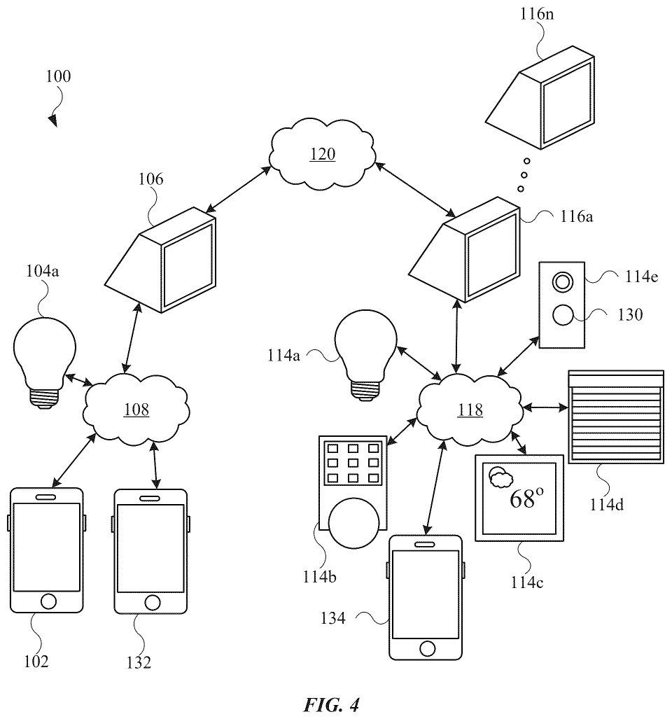

FIG. 4 illustrates the network environment 100 in which the electronic device 102 may obtain source information that causes a change of state of the network device 114a, in accordance with aspects of the present disclosure. For purposes of simplicity, some devices of the network environment 100 are not shown. However, additional devices of network environment 100 are shown. For example, the network environment 100 may include an electronic device 132 and an electronic device 134, with the electronic device 132 communicatively coupled to the network 108 and the electronic device 134 registered on the network 118. Each of the electronic devices 132 and 134 may take any form described herein for the electronic device 102. In one or more implementations, the electronic device 132 is the device type similar to that of the electronic device 102 and the network 108 (e.g., the device type 126a shown in FIG. 3). Also, in one or more implementations, the electronic device 134 is the device type similar to that of the network 118 (e.g., the device type 126b shown in FIG. 3). Accordingly, the electronic devices 132 and 134 include different device types, with the electronic device 132 capable of communicating over the network 108, and the electronic device 134 capable of communicating over the network 118. Conversely, the electronic device 132 may not communicate over the network 118, and the electronic device 134 may not communicate over the network 108.

In addition to the electronic device 102, the electronic device 132 may also generate a command to the network device 114a to change a state of the network device 114a. For example, using the network 120, the electronic device 132 may provide the command to the network device 114a. As a non-limiting example, the electronic device 132 may tag the command with metadata identifying the electronic device 132 and/or the type of command generated by the electronic device 132. Additionally, the network 120 may log, or store, the command from the electronic device 132 as an event and provide, using a controller (e.g., universal controller 122 shown in FIG. 3), the event to the electronic device 102. The electronic device 102 can provide the user with a notification (e.g., on a display of the electronic device 102) indicating the electronic device 132 generated the control to change the state of the network device 114a. Moreover, the notification provided to the electronic device 102 may not only indicate the electronic device 132 generated the control, but also what change the control caused to the network device 114a. For example, when the network device 114a takes the form of a light (representing a smart lighting system), the notification to the electronic device 102 may include an indication as to whether the command from the electronic device 132 turned on the light, turned off the light, or created a script to automatically turn on or turn off the lights, as well and when the command occurred. Beneficially, a user of the electronic device 102 may determine which device and/or who (e.g., the user of the electronic device 132) provided the control to the network device 114a and how the network device 114a was controlled based on the command. Further, the network 120 may support the commands from the electronic device 102 and the electronic device 132 to the network device 114a, despite the network 108 supporting the electronic devices 102 and 132 and the network 118 supporting the network device 114a.

Also, the network 120 may support notifications indicating a change of state to the network device 114a, even when the devices are part of different operating systems and different interconnected systems. For example, the electronic device 134 may also generate a command to the network device 114a to change a state of the network device 114a, and the network 120 may log the command from the electronic device 134 as an event, and may provide, using a controller, the event to the electronic device 102. Beneficially, a user of the electronic device 102 may again determine which device and/or who (e.g., the user of the electronic device 134) provided the control to the network device 114a and how the network device 114a was controlled, despite the network 108 supporting the electronic device 102 and the network 118 supporting the network device 114a and the electronic device 134.

In one or more implementations, the electronic device 132 may run a software application used to interact with (e.g., provide a command to) at least one of the network device 114a or the network 118. The user of the electronic device 132 may utilize the software application to authorize the network 118 to release information used to identify the electronic device 132, which may also include a user of the electronic device 132. For example, when the electronic device 132 provides a command to change a state of the network device 114a, the network 120 may log the event as being performed by the electronic device 132. Based on the authorization provided by the electronic device 132, the network 118 may provide, via the network 120, to the network 108 information related to the electronic device 132 changing the state of the network device 114a. As a result, another electronic device (e.g. the electronic device 102) connected to the network 108 may receive a notification via the network 108 that the electronic device 132 generated the command to change the state of the network device 114a.

Additionally, the network 120 may support notifications indicating a change of state to the network device 114a based on direct interaction with the network device 114a. For example, when a user interacts (e.g., manually interacts) with the network device 114a to change the state of the network device 114a, the network 120 may log the event as a change of state to the network device 114a as a manual interaction by the user. When the network device 114a takes the form of a light (representing a smart lighting system), the notifications to the electronic device 102 may include an indication as to whether the user increased or decreased a light intensity or brightness of the light, turned on or off the light, changed the appearance (e.g., color) of the light, as well as when the interaction by the user occurred.

In one or more implementations, the network 120 may support notifications indicating a change of state to the network device 114a, including hiding or obscuring which device provided the change of state to the network device 114a. For example, when the electronic device 132 generates a command to change a state of the network device 114a, the notification may be encoded by at least one of the network 108 or the network 120. As non-limiting examples, the notification may include an opaque identifier or one-way hash. As a result, devices (e.g., the electronic device 134) running on a different device type than that of the electronic device 132 and on a different network than that of the electronic device 132 may not determine or identify that the electronic device 132 provided the command to change the state of the network device 114a, despite the electronic devices 132 and 134 both being in communication with the network 120. However, the electronic device 102, having the same device type and in communication with the same network (e.g., network 108) as that of the electronic device 132, may decode the notification or receive, via the network 120, a decoded notification indicating the electronic device 132 generated the command to change the state of the network device 114a. Additionally, in a similar manner, it should be noted that the electronic device 102 may generate the command to change the state of the network device 114a, which may be encoded so as to prevent identification of the electronic device 102 by the electronic device 134 but subsequently decoded and provided to the electronic device 132. Beneficially, the network 120 may support one-way sharing of source information as to which device provided the command to the network device 114a, thus limiting the sharing to devices of the same device type and on the same home network.

Additionally, using the electronic device 102, a user may initiate a script to automatically control network devices on a network. A script may include, for example, a set of one or more automation rules. For example, the electronic device 102 may establish a script that controls the network device 114d (e.g., motorized blind), which is connected to the network 118, to change the state (e.g., open and close) network device 114d in accordance with the established script, such as to open the blinds in the morning and to close the blinds at night. Using the electronic device 102, the script may be provided, via network 120 and the network 118, as instructions to the network device 114d to automatically change the state of the network device 114d. Based on the script, the network device 114d is placed in a predetermined state (e.g., closed state) for a predetermined time interval or duration. This may include general, preset hours associated with a time of day (e.g., night automation, security automation), a preset event (e.g., away automation), or a user-selected time interval or duration (e.g., beginning time and end time). The script may also include instructions to subsequently change the state (e.g., closed state to open state) of the network device 114d at the end of the preset hours or preset time. Additionally, in one or more implementations, the electronic device 102 and/or the network 108 may learn, based on a recurrence of instructions to the electronic device 102 to change the state of (e.g., close and open) the network device 114d at or within a time interval.

While the network device 114d is operating in accordance with the script, the network device 114d may receive a request that includes instructions to change the state of the network device 114d from a source (e.g., another device). For example, the electronic device 134 may provide, via the network 118, instructions to the network device 114d to request a change the state of the network device 114d, which may conflict with the state previously established by script provided by the electronic device 102. The electronic device 102 may receive, via the networks 108, 118, and 120, a notification that the network device 114d received a request with instructions to change its state. The electronic device 102 may notify (e.g., via a display) the user that a source (e.g., the electronic device 134) provided a request to change the state of the network device 114d while the network device 114d is operating in accordance with the script. The notification may provide the user with one or more options from which to select. For example, the electronic device 102 may provide, at the display, a display prompt such as “Do you want to override the request from the electronic device?” The user may respond in the negative to the display prompt from the electronic device 102, thus preventing the electronic device 134 from operating the network device 114d in the requested state. By overriding the request from the electronic device 134, the electronic device 102 may prevent the change of state of the network device 114d thus maintaining the network device 114d operating in accordance with a state requested by the script. Alternatively, if the state of the network device 114d was already changed based on the instructions included in the request from the electronic device 134, the electronic device 102 may display a display prompt such as “Do you want to revert the network device to its prior state?” The user may respond in the affirmative to the display prompt from the electronic device 102, thus overriding the electronic device 134 and causing the network device 114d to change back to its prior state (e.g., before the change requested by the electronic device 134). Further, the user may use the electronic device 102 to select an input from the display prompt to accept the request to change the state of the network device 114d. It should be noted that in additional to the examples for the network device 114d, other network devices, such as the network devices 114a and 114b, may be operated in accordance with a predetermined state (e.g., network device 114a is off and the network device 114b is locked) for a predetermined duration or time interval.

Additionally, using the electronic device 102, the user can establish the network 108 as a superseding network. In this regard, instructions from the network 108 to change the state of network devices (e.g., network devices 114a, 114b, 114c, 114d, and 114e) on the network 118 will override instructions provided by other networks (e.g., the network 118) generated by other devices (e.g., electronic device 134) to change the state of the network devices on the network 118. As a result, instructions from the network 108, when established as a superseding network, can prevent a change of state of the network devices on the network 118, or undo and change the state of the network devices (e.g., back to the prior state). Additionally, when the network 108 is established as the superseding network, the network 108 may provide instructions to the network 120 to remove other devices (e.g., network hub 116a) or networks (e.g., the network 118) from communication with the network 120. This may, for example, prevent the network devices 114a, 114b, 114c, 114d from functioning based on undesired instructions (e.g., commands, scripts) from other devices (e.g., electronic device 134), or when a network security threat is detected.

In another example, the user may use the electronic device 102 may establish a script that controls the network device 114e to record, using a camera 130 of the network device 114e, images for an established duration or while the user is not at a location (e.g., home, building) in which the network device 114e is installed. The user may later obtain the images recorded by the camera 130 via the networks 108, 118, and 120. In this regard, the user may expect the camera 130 to stop recording when, for example, the established duration ends or when user returns to the location. However, in some instances, the camera 130 may continue to record images despite the user's expectation of no further recording. For example, the electronic device 134 may provide instructions (e.g., command, script) to the network device 114e, via the network 118, to cause the camera 130 to record images, with the instructions provided by the electronic device 134 being contrary to the instructions provided by the electronic device 102.

In order to resolve this conflict, one or more conflict resolution mechanisms may be implemented. For example, the electronic device 102 may receive data indicating the camera 130 is still recording and provide a notification, based on the data, to the user at, for example, a display of the electronic device 102. The notification may include various messages, such as a message indicating the camera 130 is still recording, the source (e.g., electronic device 134) attributed to cause the camera 130 continuing to record, and/or an inquiry whether the user would like the camera 130 to continue recording. When the inquiry message is provided by the electronic device 102, the electronic device 102 may allow the user to respond in the affirmative or negative. In this regard, if the electronic device 102 receives a response (e.g., input to the display) in the negative, the electronic device 102 may send instructions to the camera 130 to cease recording. Moreover, in one or more implementations, the electronic device 102 may send instructions, based on a user input, to the network 118 to remove the network device 114e from the network 118.

Additionally, if the camera 130 is streaming to a cloud-based network, the electronic device 102 may receive data indicating the camera 130 is streaming to the cloud-based network. The electronic device 102 may provide a notification, based on the data, to the user at, for example, a display of the electronic device 102. The notification may include various messages, such as a message indicating the camera 130 is streaming to the cloud-based network, the source (e.g., electronic device 134) attributed to cause the camera 130 to continue streaming, and/or an inquiry whether the user would like the camera 130 to continue streaming. When the inquiry message is provided by the electronic device 102, the electronic device 102 may allow the user to respond in the affirmative or negative. In this regard, if the electronic device 102 receives a response (e.g., input in response to the display) in the negative, the electronic device 102 may send instructions to the camera 130 to cease streaming. While the camera 130 is shown as being integrated with a doorbell (e.g., smart doorbell), in other implementations, the camera 130 takes the form of a standalone network device (e.g., standalone camera) that is mountable indoors and/or outdoors.

In another example, when the network hub 106 and the network hubs 116a and 116n (e.g., each of the n network hubs) take the form of a network manager (e.g., router, access point), the network hub 106a and network hubs 116a and 116n may be used to provide access to one or more of the networks 108, 118, and 120. Using the electronic device 102, a user may connect the network device 104a to the network 108, which may require providing, via the electronic device 102, network credentials to (e.g., network name, network password) to the network hub 106a. Similarly, using the electronic device 134, another user may connect any one or more of the network devices 114a, 114b, 114c, 114d, and 114e to the network 118, which may require providing, via the electronic device 134, network credentials to the network hub 116a.

Additionally, networks hubs may assign an identifier to network devices as well as an identifier to devices on the network used to change the state of the network devices, with the identifier being specific to each device. Moreover, in some instances, each network hub exchanges, or sends and receives, the respective identifiers with other networks, thus providing networks and/or devices with the ability to identify not only a change of state of a network device but also which device is the source attributed to changing the state of the network device. For example, the network hub 106 may assign an identifier of 10 to the network device 104a, an identifier of 20 to the electronic device 102, and an identifier of 30 to the electronic device 132. In a similar manner, the network hub 116a may assign an identifier of 50 to the network device 114a, and an identifier of 60 to the electronic device 134. Each of the identifiers may be selected by a predetermined process or by a pseudo-random process. Also, each of the identifiers selected by the network hubs 106 and 116a may not be used more than once by the same network. Also, while the identifiers described herein are numeric identifiers, other identifiers may be used including, but not limited to, letters or alphanumeric characters.

Based on a user request or some protocol to determine source attribution, each of the network hubs 106 and 116a assigns identifiers to network devices and devices (e.g., electronic devices) on their respective networks, the network hubs 106 and 116a may exchange their respective assigned identifiers. For example, when the electronic device 134 is used change the state of the network device 114a, the network hub 116a may provide data, in the form of the assigned identifiers, to the network hub 106. In this example, the network hub 116a may provide data to the network hub 106 indicating “device ID 60 changed the state of network device ID 50.” Based on the received data, the network hub 106 may determine the electronic device 134 changed the state of the network device 114a, and provide this information to the electronic device 102. Accordingly, the electronic device 102 may provide a notification to the user of the electronic device 102 indicating the electronic device 134 changed the state of the network device 114a.

Further, in some instances, identifiers generated by the network hubs 106 and 116a are also indicative of a particular user account established by a user. For example, the network hub 116a may assign an identifier of 70 to the network device 114a. The identifier 70 may also be associated with a user account used on an electronic device (electronic device 134) that was used by a user (e.g., User A) to establish the network device 114a on the network 118. Accordingly, identifier 70 may be associated with both the electronic device 134 and the user account, and thus, the identifier 70 may be associated with User A. The identifier 70 may subsequently be shared by the network hub 116a with the network hub 106. Moreover, the network hub 116a may share with the network hub 106 that identifier 70 is also associated with the user account that belongs to User A. In this regard, when the electronic device 134 changes the state of the network device 114a, the network hub 116a may provide data to the network 108 indicating “ID 70 changed the state.” Based on the received data, the network hub 106 may determine User A, the user of the electronic device 134, changed the state of the network device 114a, and provide this data to the electronic device 102, and the electronic device 102 may provide a notification to a user. Thus, the user knows User A changed the state of the network device 114a. In a similar manner, the network hub 106 may assign an identifier of 72 to the network device 104a. The identifier 72 may also be associated with a user account used on an electronic device (electronic device 102) that was used by a user (e.g., User B) to establish the network device 104a on the network 108. Accordingly, identifier 72 may be associated with both the electronic device 102 and the user account, and thus, the identifier 72 may be associated with User B. The identifier 76 may subsequently be shared by the network hub 106 with the network hub 116a. Moreover, the network hub 106 may share with the network hub 116a that identifier 72 is also associated with the user account that belongs to User B. In this regard, when the electronic device 134 receives identifier 72, the electronic device 134 may determine not only the electronic device 102 changed the state of the network device 104a, but also User B is the person that changed the state of the network device 104a using the electronic device 102.

In some instances, multiple devices may be used to determine source attribution associated with a change of state of a network device. For example, when the network device 114b undergoes a change of state (e.g., lock, unlock), the network hub 116a may provide data indicating the change of state of the network device 114b to the network hub 106, and the network hub 106 may provide the data to the electronic device 102, thus allowing the electronic device 102 to provide a notification, to a user, indicative of the change of state of the network device 114b. However, when the change of state of the network device 114b was manually performed (e.g., without the use of the electronic device 134 and an associated identifier(s)), no indication of the source of the change of state may be provided to the electronic device 102 and the source attributed to the change of state is unknown to the user of the electronic device 102.

However, in some instances, an image sensor (e.g., camera) may be used to observe a network device. For example, the camera 130 of the network device 114e may be oriented such that the network device 114b is in the field of view of the camera 130, thus allowing the camera 130 to observe the network device 114b, and record images and/or stream images to the network hub 106. Accordingly, the camera 130 may capture one or more images of a person changing the state of the network device 114b by manually interacting with the network device 114b. When the one or more captured images are provided to the network hub 106, the network hub 106 may provide information (e.g., the one or more captured images) to the electronic device 102. In this regard, when the user of the electronic device 102 views the one or more captured images and knows the identity of the person, the user may determine the source (e.g., the person in the image(s)) of the state of change of the network device 114b based in part on the network device 114e, including the camera 130 of the network device 114e.

In one or more implementations, several factors are used to identify the person changing the state of a network device. For example, when viewing the one or more images from the camera 130, the user may associate an identifier (e.g., name) of a person in the image(s) and provide the identifier to the electronic device 102 and/or the network hub 106. Based on a recurrence of captured images, the electronic device 102 and/or the network hub 106 may learn the person in the captured images that changes the state of the network device 114b. For example, the electronic device 102 and/or the network hub 106 may compare the subsequent images with the previously provided images to determine whether the subsequent images is the person in the previously provided images. In this regard, facial features (e.g., nose, eyes, mouth, cheeks) may be compared, using the electronic device 102 and/or the network hub 106, between subsequent images is the person in the previously provided images to determine whether the person is present and changing the state of the network device 114b. Accordingly, using the identifier and the recurrence, the electronic device 102 and/or the network hub 106 may be trained to identify, including automatically identify, a person that is manually changing the state of the network device 114b based on images from the network device 114e. Additional data such as the date and time the camera 130 captured the person changing the state of the network device 114b may be used as training data to identify the person. For example, the recurrence of the generally same time (e.g., with in a predetermined interval) over the course of several days may be used to further train the electronic device 102 and/or the network hub 106. While the example described herein is applied to the network device 114b, a determination of the source of manual changing of other network devices may also be performed.

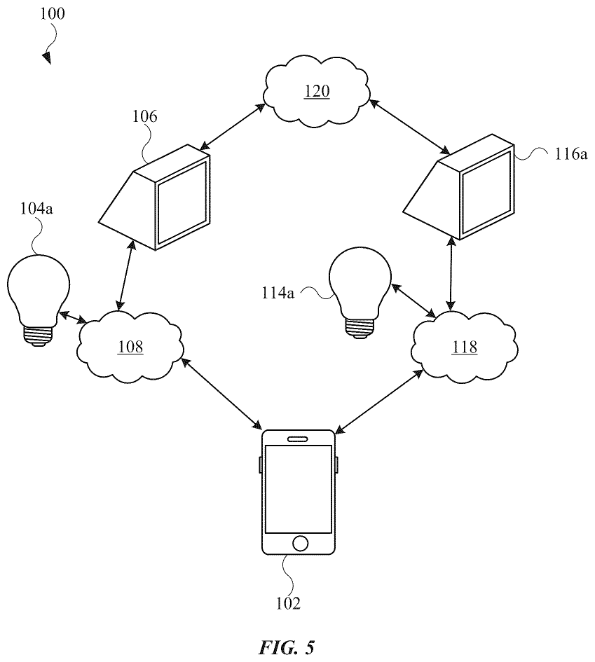

FIG. 5 illustrates the network environment 100 in which the electronic device 102 may obtain source information based on a user having user accounts on different network, in accordance with aspects of the present disclosure. In some instances, a user (e.g., a single user) may establish multiple user accounts to control the state of network devices, with each user account associated with a particular network. This may be utilized when different network devices (e.g., network devices 104a and 114a) run on different networks (e.g., networks 108 and 118) and include different device types (e.g., different operating systems). For example, using the electronic device 102, the user may establish a user account (e.g., User Account A) associated with the network 108, thus allowing the user to change the state of the network device 104a via the network 108. Additionally, using the electronic device 102, the user may establish an additional user account (e.g., User Account B) associated with the network 118, thus allowing the user to change the state of the network device 114a via the network 118. In this regard, each of the established user accounts are associated with the user but are on different networks. When this occurs, each of the networks 108 and 118 may generate and assign, for each account, identifiers associated with a network device as well as with a particular user account, and subsequently exchange (e.g., send and receive) the identifiers with each other. However, in one or more implementations, the exchange of identifiers between the networks 108 and 118 may not occur unless the user first opts in and provides consent for the exchange. Alternatively, the network 120 may generate and assign, for each account, identifiers associated with a network device as well as with a particular user account, and provide the identifier to each of the networks 108 and 118. Beneficially, the exchange of identifiers allows one or more networks to reconcile the same user having different user accounts on different networks, thus allowing networks to better determine the source of a change of state of network devices is a particular person with accounts on different networks.

As an example, the network 108 may generate and assign an identifier 82 to the network device 104a and to the user account (e.g., User Account A) established on the network 108. Similarly, the network 118 may generate and assign an identifier 84 to the network device 114a and to the user account (e.g., User Account B) established on the network 118. The networks 108 and 118 may exchange data in the form of identifier information. In this regard, when a change of state to the network device 114a occurs and the network 118 provides data in the form on an identifier (e.g., 84) associated with the network device 114a and User Account B to the network 108, the network 108 may determine, based on comparing with the previously received identifier information from the network 118, the source of the change of state of the network device 114a is User Account B, which is associated with a user of the electronic device 102. The source generated from User Account B may include instructions (e.g., a command, a script) to change the state of the network device 114b.

The network 108 may provide data indicating the source of the change of state of the network device 114b is the user's own account (e.g., User Account B) established on the network 118. Alternatively, the network 108 may provide the data to the electronic device 102, and the electronic device 102 may determine the source of the change of state of the network device 114b is the user's own account (e.g., User Account B) established on the network 118. In either event, the user may be notified by the electronic device 102 that his/her own account (e.g., User Account B), established on the network 118, was used to change the state of the network device 114a. Accordingly, using the exchange of identifiers by the networks 108 and 118, a user may determine instructions to change the state of the network device 114a originated from his/her own user account.

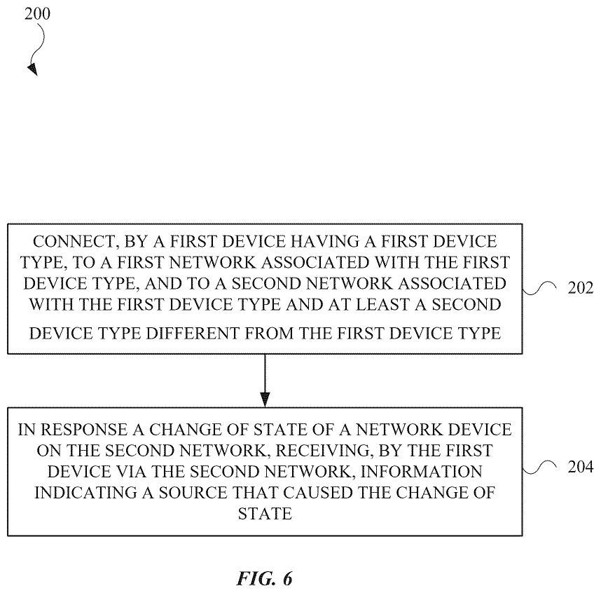

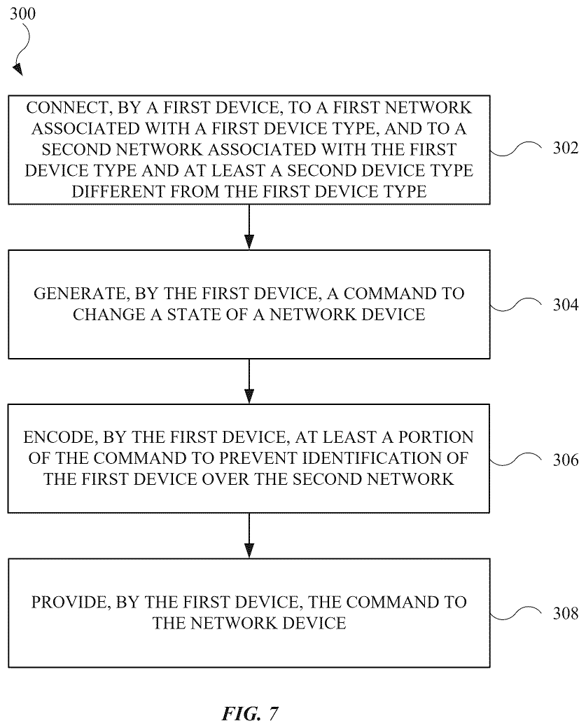

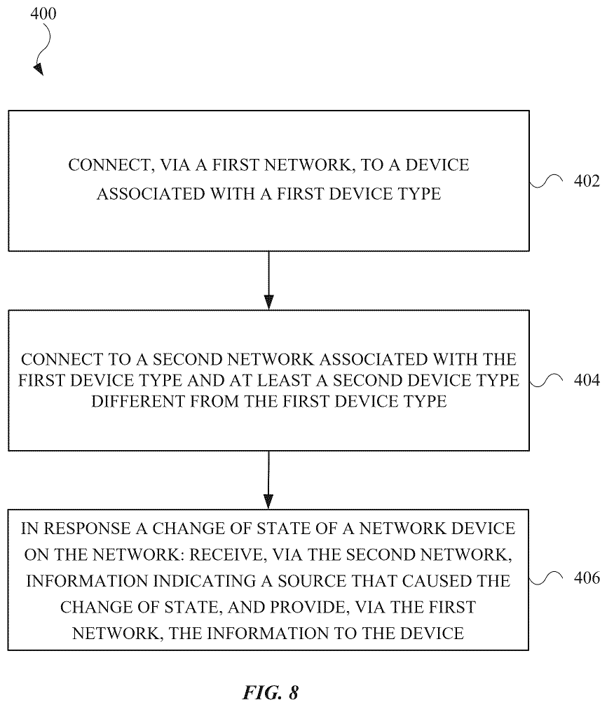

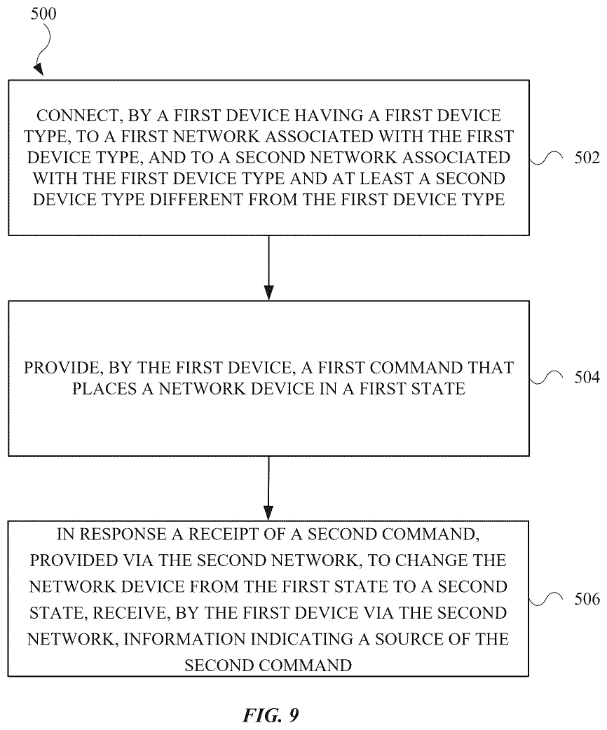

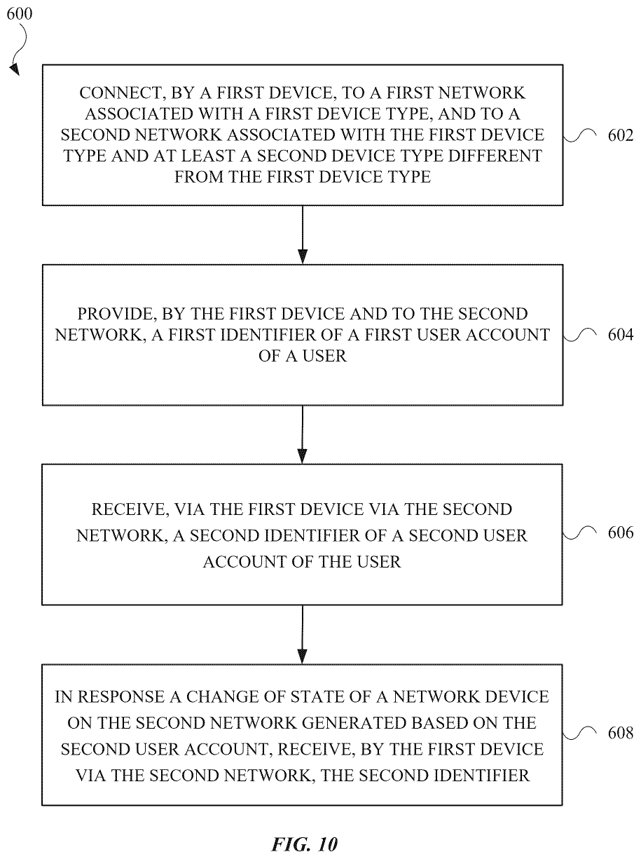

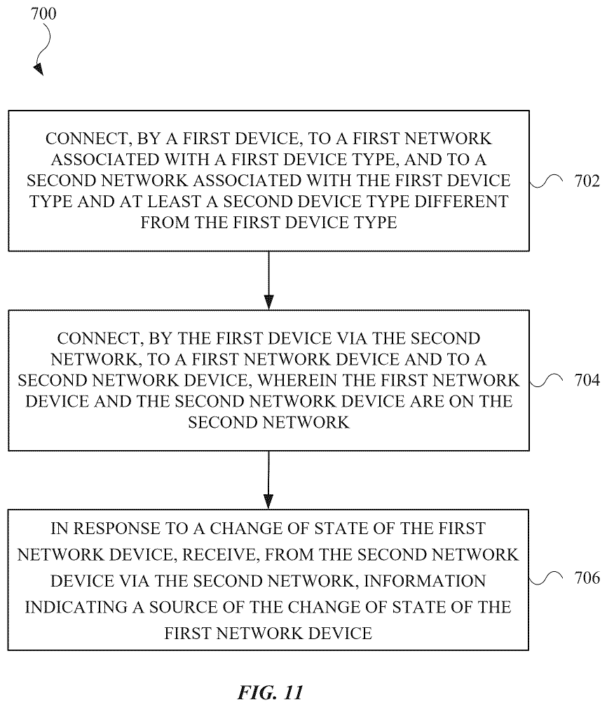

FIG. 6, FIG. 7, FIG. 8, FIG. 9, FIG. 10 and FIG. 11 illustrate flow diagrams showing examples of one or more processes that may be performed for providing source attribute distribution across disparate networks, in accordance with implementations of the subject technology. One or more devices, including one or more processors thereof and computer-readable instructions stored thereon, such as electronic devices (e.g., electronic device 102 shown in FIGS. 1-5), a network hub 106 (shown in FIGS. 1, 4 and 5), or one or more home networks (e.g., network 108 shown in FIGS. 1, 3, 4, and 5), may be used in part to conduct one or more steps of the example processes. For explanatory purposes, the respective processes shown in FIGS. 6-11 are primarily described herein with reference to the electronic device 102, which may include a smartphone, or the network 108. However, the respective processes shown in FIGS. 6-11 are not limited to the electronic device 102, and one or more blocks (or operations) of the respective processes may be performed by one or more other components of other suitable apparatuses, devices, or systems. Further for explanatory purposes, some of the blocks of the respective processes are described herein as occurring in serial, or linearly. However, multiple blocks of the respective processes may occur in parallel. In addition, the blocks of the respective processes need not be performed in the order shown and/or one or more blocks of the respective processes need not be performed and/or can be replaced by other operations.

FIG. 6 illustrates a flow diagram showing an example of a process 200 that may be performed for obtaining a source that caused a state of change to a network device, in accordance with implementations of the subject technology.

At block 202, a first device having a first device type connects to a first network associated with the first device type. Additionally, the first device connects to a second network associated with the first device type and at least a second device type different from the first device type. As non-limiting examples, the first device type and the second device type may include different operating systems. Also, the second network may take the form of a cross-ecosystem supported network (e.g., network 120 shown in FIGS. 1, 3, and 4) used to connect the first network to another, third network (e.g., network 118 shown in FIGS. 1, 3, and 4) to which the devices of the second device type are connected.

At block 204, in response to a change of state of a network device on the second network, the first device receives, via the second network, information indicating a source that caused the change of state. In one or more implementations, the network device is of second device type (e.g., a different device type than that of the first device). Also, in one or more implementations, the source includes a device (e.g., electronic device) capable of providing a command to the network to change the state of the network device. The device may include the first device type that is connected to the first network. Alternatively, the device may include the second device type that is connected to the other network to which the second network is connected. Further, the information may include an identification of the source that caused the change of state to the network device. In this regard, the information may identify an electronic device connected to the first network or another network. Alternatively, the information may indicate a user manually interacted with the network device to change the state of the network device.

FIG. 7 illustrates a flow diagram showing an example of a process 300 that may be performed for encoding information associated with a source that caused a state of change to a network device, in accordance with implementations of the subject technology.

At block 302, a first device connects to a first network associated with a first device type. Additionally, the first device connects to a second network associated with the first device type and at least a second device type different from the first device type. As non-limiting examples, the first device type and the second device type may include different operating systems. Also, the second network may take the form of a cross-ecosystem supported network (e.g., network 120 shown in FIGS. 1, 3, and 4) used to connect the first network to another, third network (e.g., network 118 shown in FIGS. 1, 3, and 4) to which the devices of the second device type are connected.

At block 304, the first device generates a command to change a state of a network device. In one or more implementations, the network device includes the second device type. The command may include data generated by, for example, a user when using the first device.

At block 306, the first device encodes at least a portion of the command to prevent identification of the first device over the second network. As a non-limiting example, the command may be encoded by an opaque identifier. Further, electronic devices with the first device type and connected to the first network may be capable of decoding the command and identifying the electronic device that generated the command. However, electronic devices with the second device type and connected to the second network may be prevented from decoding the command, thus prevented from identifying the first device.

At block 308, the first devices provides, via the first network, the command to the network device. When the network device receives the command, the network device may change its state.

FIG. 8 illustrates a flow diagram showing an alternate example of a process 400 process that may be performed for obtaining a source that caused a state of change to a network device, in accordance with implementations of the subject technology.

At block 402, a system connects, via a first network, to a device associated with a first device type. In one or more implementations, the system may be implemented as a network hub (e.g., network hub 106). Further, the device may include an electronic device, such as a smartphone, as a non-limiting example.

At block 404, the system connects to a second network associated with the first device type and at least a second device type different from the first device type. In one or more implementations, the second network takes the form of a cross-ecosystem supported network (e.g., network 120 shown in FIGS. 1, 3, and 4) used to connect the first network to another, third network (e.g., network 118 shown in FIGS. 1, 3, and 4) to which the devices of the second device type are connected.

At block 406, in response a change of state of a network device on the network, the system receives, via the second network, information indicating a source that caused the change of state and provides, via the first network, the information to the device. In one or more implementations, the network device includes the second device type.

FIG. 9 illustrates a flow diagram showing an alternate example of a process 500 that may be performed for obtaining a source that caused a state of change to a network device, in accordance with aspects of the present disclosure.

At block 502, a first device having a first device type is connected to a first network associated with the first device type. The first device is further connected to a second network associated with the first device type and at least a second device type different from the first device type. The first device may include an electronic device (e.g., electronic device 102 shown in FIG. 1). The first network may include one of the network 108 or the network 118 (both shown in FIG. 1). The second network may include the network 120 (shown in FIG. 1).

At block 504, the first device provides a first command that places a network device in a first state. In one or more implementations, the network device is on the second network. Also, based on the first command including a user request or a script, the network device may be placed in a first state. As a non-limiting example, a script may provide an automation corresponding to a mode “(e.g., night mode, security mode, away mode) and accordingly may include instructions to place the network device in the first state for a predetermined time interval.

At block 506, in response a receipt of a second command, provided via the second network, to change the network device from the first state to a second state, the first device receives, via the second network, information indicating a source of the second command. The information may include data indicating another electronic device is the source. In one or more implementations, the information further includes an identifier, in the form of numbers and/or letters, associated with the electronic device and/or associated with a user account. The user account may be associated with at least one of the first network and the second network.

FIG. 10 illustrates a flow diagram showing an alternate example of a process 600 that may be performed for obtaining a source that caused a state of change to a network device, in accordance with aspects of the present disclosure.

At block 602, a first device is connected to a first network associated with a first device type, and to a second network associated with the first device type and at least a second device type different from the first device type. The first device may include an electronic device (e.g., electronic device 102 shown in FIG. 1). The first network may include one of the network 108 or the network 118 (both shown in FIG. 1). The second network may include the network 120 (shown in FIG. 1).

At block 604, the first device provides, to the second network, a first identifier of a first user account of a user. The first identifier may include generated numbers and/or letters specific to the first user account.

At block 606, the first device receives, via the second network, a second identifier of a second user account of the user. The second identifier may include generated numbers and/or letters specific to the second user account. Accordingly, the first and second identifiers are different.

At block 608, in response a change of state of a network device on the second network generated based on the second user account, the first device receives, via the second network, the second identifier. The first device may determine the source of the change of state of the network device is one of the user's accounts (e.g., the second user account).

FIG. 11 illustrates a flow diagram showing an alternate example of a process 700 that may be performed for obtaining a source that caused a state of change to a network device, in accordance with aspects of the present disclosure.

At block 702, a first device is connected to a first network associated with a first device type, and to a second network associated with the first device type and at least a second device type different from the first device type. The first device may include an electronic device (e.g., electronic device 102 shown in FIG. 1). The first network may include one of the network 108 or the network 118 (both shown in FIG. 1). The second network may include the network 120 (shown in FIG. 1).

At block 704, the first device is connected, via the second network, to a first network device and to a second network device. In one or more implementations, the first network device and the second network device are on the second network.

At block 706, in response to a change of state of the first network device, information is received, from the second network device via the second network, indicating a source of the change of state of the first network device. In one or more implementations, the second network device includes an image sensor (e.g., camera) that monitors the first network device (e.g., door lock) and captures one or more images of the first network devices, including a person manually interacting with the first network device.

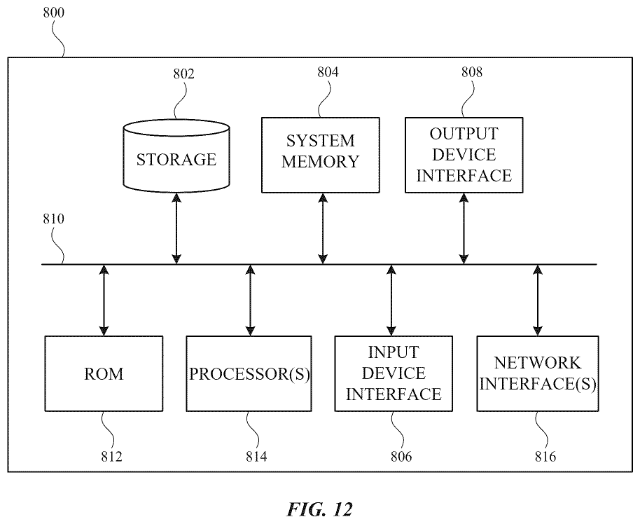

FIG. 12 illustrates an electronic system 800 with which one or more implementations of the subject technology may be implemented. The electronic system 800 can be, and/or can be a part of, the electronic device 102 or the network 108 as shown in FIG. 1. The electronic system 800 may include various types of computer readable media and interfaces for various other types of computer readable media. The electronic system 800 includes a bus 810, one or more processing units 814, a system memory 804 (and/or buffer), a ROM 812, a permanent storage device 802, an input device interface 806, an output device interface 808, and one or more network interfaces 816, or subsets and variations thereof.

The bus 810 collectively represents all system, peripheral, and chipset buses that communicatively connect the numerous internal devices of the electronic system 800. In one or more implementations, the bus 810 communicatively connects the one or more processing units 814 with the ROM 812, the system memory 804, and the permanent storage device 802. From these various memory units, the one or more processing units 814 retrieves instructions to execute and data to process in order to execute the processes of the subject disclosure. The one or more processing units 814 can be a single processor or a multi-core processor in different implementations.

The ROM 812 stores static data and instructions that are needed by the one or more processing units 814 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random access memory. The system memory 804 may store any of the instructions and data that one or more processing units 814 may need at runtime. In one or more implementations, the processes of the subject disclosure are stored in the system memory 804, the permanent storage device 802, and/or the ROM 812 (which are each implemented as a non-transitory computer-readable medium). From these various memory units, the one or more processing units 814 retrieves instructions to execute and data to process in order to execute the processes of one or more implementations.

The bus 810 also connects to the input device interface 806 and output device interface 808. The input device interface 806 enables a user to communicate information and select commands to the electronic system 800. Input devices that may be used with the input device interface 806 may include, for example, alphanumeric keyboards and pointing devices (also called “cursor control devices”). The input device interface 806 may enable, for example, the display of images generated by electronic system 800. Output devices that may be used with the input device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 12, the bus 810 also couples the electronic system 800 to one or more networks and/or to one or more network nodes, such as the electronic device 102 and network device 104a, 104b, 104c, 104d, 104e, 114a, 114b, 114c, 114d, and 114e shown in FIG. 1, through the one or more network interfaces 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, and/or any other optical or magnetic media. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

As described above, one aspect of the present technology is the gathering and use of data available from specific and legitimate sources for providing source attribute distribution across disparate networks. The present disclosure contemplates that in some instances, this gathered data may include personal information data that uniquely identifies or can be used to identify a specific person. Such personal information data can include audio data, voice data, demographic data, location-based data, online identifiers, telephone numbers, email addresses, home addresses, encryption information, data or records relating to a user's health or level of fitness (e.g., vital signs measurements, medication information, exercise information), date of birth, or any other personal information.

The present disclosure recognizes that the use of personal information data, in the present technology, can be used to the benefit of users. For example, the personal information data can be used for providing source attribute distribution across disparate networks.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of source attribute distribution across disparate networks, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
connecting, by a first device having a first device type, to a first network associated with the first device type, and to a second network associated with the first device type and at least a second device type different from the first device type; and
in response a change of state of a network device on the second network, receiving, by the first device via the second network, information indicating a source that caused the change of state.

2. The method of claim 1, wherein:
the first network is a first home network configured to communicatively couple devices having the first device type, and
the second network is a second home network configured to communicatively couple devices having the first device type or second device type.

3. The method of claim 2, wherein:
the first device type is configured to communicate over the first home network or the second home network, and
the second device type is configured to communicate over the second home network but not the first home network.

4. The method of claim 1, wherein receiving the information comprises receiving an indication that the source comprises a second device registered on one of the first network or the second network.

5. The method of claim 1, wherein the network device comprises the second device type.

6. The method of claim 1, wherein receiving the information comprises receiving an indication that the source comprises a manual interaction by a user with the network device.

7. The method of claim 1, wherein the receiving the information comprises receiving an indication that source comprises an automated change by the network device.

8. The method of claim 1, further comprising requesting, by the first device, authorization from the second network to provide the source to the first network.

9. A non-transitory computer-readable medium, comprising:
computer-readable instructions that, when executed by a processor, cause the processor to perform one or more operations comprising:
connecting, by a first device, to a first network associated with a first device type, and to a second network associated with the first device type and at least a second device type different from the first device type;
generating a command to change a state of a network device;
encoding, by the first device, at least a portion of the command to prevent identification of the first device over the second network; and
providing, by the first device via the first network, the command.

10. The non-transitory computer-readable medium of claim 9, further comprising encoding the command to prevent the identification of the first device by a third network communicatively coupled with the second network, wherein the third network is associated with the second device type.

11. The non-transitory computer-readable medium of claim 9, wherein:
the first network is configured to communicatively couple devices having the first device type, and
the second network is configured to communicatively couple devices having the first device type or second device type.

12. The non-transitory computer-readable medium of claim 11,
the first device type is configured to communicate over the first or second network, and
the second device type is configured to communicate over the second network but not the first network.

13. The non-transitory computer-readable medium of claim 9, further comprising receiving, by the first device via the first network, information comprising an indication that a second device changed the state of the network device.

14. The non-transitory computer-readable medium of claim 9, further comprising:
receiving, by the first device via the second network, an indication of a change to the state of the network device; and
requesting, by the first device and to the second network, a source of the change.

15. The non-transitory computer-readable medium of claim 14, further comprising receiving, by the first device and from the second network, the source.

16. The non-transitory computer-readable medium of claim 9, further comprising in response to a second device on the first network causing a change of state to the network device, receiving, by the first device via the second network, an indication that the second device is a source that caused the change of state.

17. A system, comprising:
a memory; and
a processor configured to:
connect, via a first network, to a device associated with a first device type,
connect to a second network associated with the first device type and at least a second device type different from the first device type, and
in response a change of state of a network device on the second network:
receive, via the second network, information indicating a source that caused the change of state, and
provide, via the first network, the information to the device.

18. The system of claim 17, wherein the processor is further configured to:
obtain, from the device, authorization to release information obtained by the second network, the information comprising the source; and
obtain, from the second network and based on the authorization, the information.

19. The system of claim 17, wherein the processor is further configured to determine, based on the information, the source comprises a second device on the second network.

20. The system of claim 17, wherein the processor is further configured to:
provide, via the first network, a command to change a state of the network device; and
encode the command to prevent identification by the second network.
